(19) United States
(12) Patent Application Publication
(10) Pub. No.: US 2010/0039376 A1
(43) Pub. Date: Feb. 18, 2010

(54) SYSTEM AND METHOD FOR REDUCING POWER CONSUMPTION OF A DISPLAY DEVICE

(75) Inventor: CHO-HAO WANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/465,554

(22) Filed: May 13, 2009

(30) Foreign Application Priority Data
Aug. 18, 2008 (CN) 200810303935.1

(51) Int. Cl. G06F 3/01

(52) U.S. Cl. 345/156; 348/78

(57) ABSTRACT

A system and method for reducing power consumption of a display device initializes a counter as zero, controls a video camera to capture an image of an object that is in front of the display device, and determines whether any user's eyes are viewing the display device by analyzing facial features of the captured image. The system and method further controls the display device to work in a normal display mode if any user's eyes are viewing the display device, and increments the counter each second if no user's eyes are viewing the display device. Additionally, the system and method controls the display device to work in a display protection mode if the counter is more than a first predefined threshold number and less than a second predefined threshold number, and in a power reducing mode if the counter is not less than the second predefined threshold number.

### BACKGROUND

1. Technical Field

Embodiments of the present disclosure relate to systems and methods for reducing energy of electronic devices, and more particularly to a system and method for reducing power consumption of a display device.

2. Description of Related Art

When people want to save energy in the world, it is essential to heighten their awareness of energy conservation. To realize this, a number of energy reducing products have been developed. With respect to electrical energy, much emphasis has been place to reduce the power consumption of electrical equipment which consume a large amount of power, such as air-conditioners, television sets, or display devices.

In order to save the power consumption of a display device connected to a computer, it is a known practice for the computer to switch the display device into an energy reducing state. The period of a predetermined time before the display device changes to the energy reducing state is set in the operating system of the computer. After the predetermined time has elapsed, the computer switches the display device into the energy reducing state by executing a display protection program. However, the predetermined time is fixed and cannot timely be changed once the predetermined time is set by a user. This problem may result in limiting the display protection program to save the power consumption in real time. Therefore, there is a improved system and method for reducing power consumption of a display device, which can overcome the above-mentioned problems.

### BRIEF DESCRIPTION OF THE DRAWINGS

FIG. 1 is a schematic diagram of one embodiment of a system for reducing power consumption of a display device.

FIG. 2 is a block diagram of function modules of the system in FIG. 1.

FIG. 3 is a flowchart of one embodiment of a method for reducing power consumption of a display device by using the system of FIG. 1.

FIG. 4 is one embodiment of a designated area in front of the display device.

### DETAILED DESCRIPTION

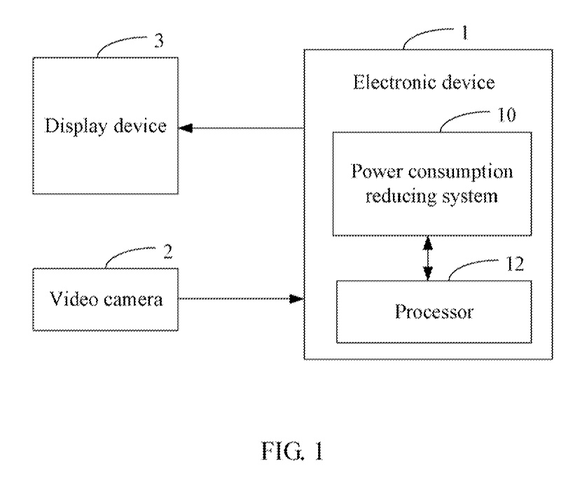

FIG. 1 is a schematic diagram of one embodiment of a system 10 for reducing power consumption (hereinafter “the power consumption reducing system 10”) of a display device 3. The power consumption reducing system 10 is included in and implemented by an electronic device 1, which is connected with, or installed with, a video camera 2 and the display device 3. The electronic device 1 may include at least one processor 12 that is operable to execute the power consumption reducing system 10. The electronic device 1 may be a computer, a television set, a mobile phone, a personal digital assistant (PDA) device, and any other electronic device having display functions. In one embodiment, the power consumption reducing system 10 is included in a readable medium of the electronic device 1. In another embodiment, the power consumption reducing system 10 may be included in an operating system of the electronic device 1.

The video device 2 is operable to capture an image of an object that is in front of the display device 3 in real time, and send the image to the electronic device 1.

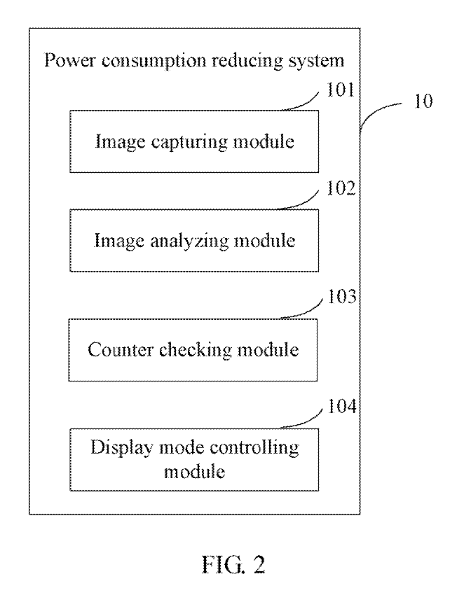

FIG. 2 is a block diagram of function modules of the power consumption reducing system 10 of the electronic device 1. In one embodiment, the power consumption reducing system 10 may include an image obtaining module 101, an image analyzing module 102, a counter checking module 103, and a display mode selecting module 104. Each of the function modules 101-104 can be executed by the at least one processor 12 of the electronic device 1.

The image capturing module 101 is operable to control the video camera 2 to capture the image of the object that is in front of the display device 3 in real time.

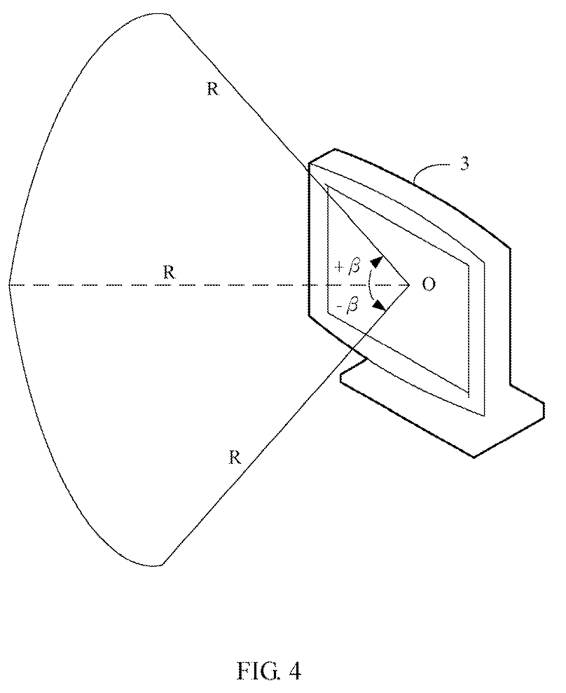

The image analyzing module 102 is operable to determine whether any user's eyes are viewing the display device 3 by analyzing facial features of the captured image. In the embodiment, the image analyzing module 102 analyzes the facial features of the captured image to detects user's eyes in the captured image, to determine whether the detected user's eyes are in a designated area in front of the display device 3, and to determine whether the user's visual angle is within a preset visual angle range if the detected user's eyes are in the designated area. Referring to FIG. 4, the designated area may be an arc-shaped area having arc radius R=60 cm in front of the display device 3, and an arc angle from β=−60 degrees to β=+60 degrees deviated from a vertical direction of the display device 3, in one example. As such, the preset visual angle range can be predefined as −60 degrees to +60 degrees that is deviated from the vertical direction of the display device 3.

The counter checking module 103 is operable to initialize a counter as zero, and increments the counter each second if no user's eyes are viewing the display device 3.

The display mode controlling module 104 is operable to control the display device 3 to work in a certain display mode according to a value of the counter. The display mode may include a normal display mode, a power reducing mode, and a display protection mode. In one embodiment, the display mode controlling module 104 controls the display device 3 to work in the normal display mode if the value of the counter is less than a first predefined threshold number. The first predefined threshold number can be predefined, for example, as 10 seconds. The display mode controlling module 104 controls the display device 3 to work in the display protection mode if value of the counter is between the first predefined threshold number and a second predefined threshold number. The second predefined threshold number can be predefined, for example, as 60 seconds. The display mode controlling module 104 controls the display device 3 to work in the power reducing mode if the value of the counter is equal to or more than the second predefined threshold number. When the display device 3 works in the power reducing mode, the display device 3 may shut down the power automatically. In addition, the display mode controlling module 104 controls the display device 3 to work in the normal display mode continuously if any user's eyes are viewing the display device 3.

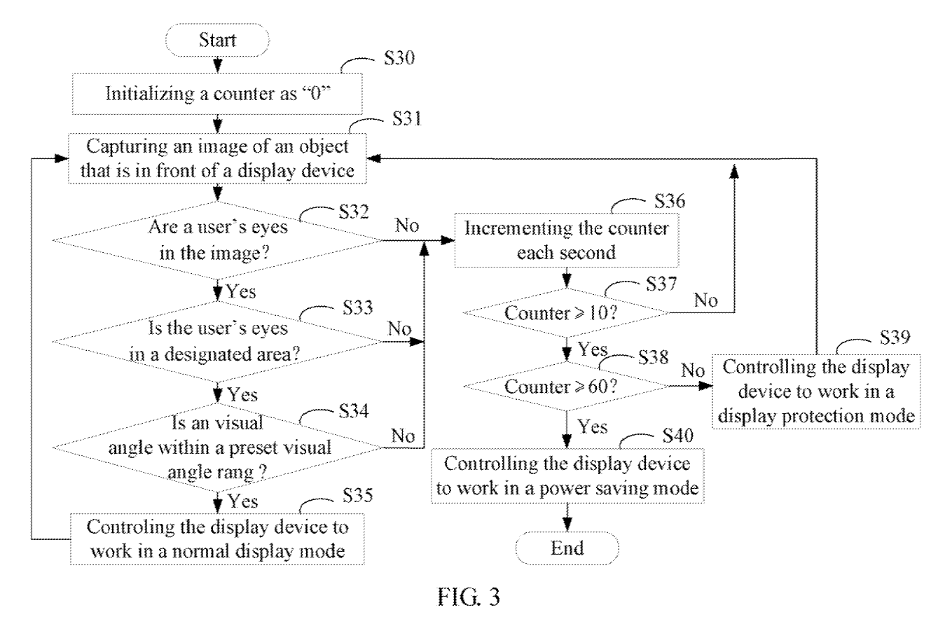

FIG. 3 is a flowchart of one embodiment of a method for reducing power consumption of a display device by using the system 10 of FIG. 1 as described above. Depending on the embodiment, additional blocks may be added, others removed, and the ordering of the blocks may be changed.

In block S30, the counter checking module 103 initializes a counter as zero. In block S31, the image capturing module 101 controls the video camera 2 to capture a image of an object that is in front of the display device 3.

In block S32, the image analyzing module 102 analyzes facial features of the captured image to determine whether a user's eyes are in the captured image. If the user's eyes are in the captured image, in block S33, the image analyzing module 102 determines whether the user's eyes are in a designated area in front of the display device 3. Otherwise, if the user's eyes are not in the captured image, the procedure goes to block S36 as described below. Referring to FIG. 4, the designated area may be an arc-shaped area having arc radius R=60 cm in front of the display device 3, and an arc angle from β=−60 degrees to β=+60 degrees deviated from a vertical direction of the display device 3, in one example.

If the user's eyes are in the designated area, in block S34, the image analyzing module 102 determines whether the user's visual angle is within a preset visual angle range. Otherwise, if the user's eyes are not in the designated area, the procedure goes to block S36 as described below. In one embodiment, the preset visual angle range can be predefined as −60 degrees to +60 degrees that is deviated from the vertical direction of the display device 3.

If the user's visual angle is within the preset visual angle range, in block S35, the display mode controlling module 104 controls the display device 3 to work in a normal display mode. Otherwise, if the user's visual angle is not within the preset visual angle range, the procedure goes to block S36 as described below.

In block S32 as described above, if the user's eyes are not in the captured image, in block S36, the counter checking module 103 increments the counter each second and detects the counter in real time.

In block S37, the counter checking module 103 determines whether a value of the counter is greater than a first predefined threshold number (e.g., 10 seconds). If the value of the counter is no greater than the first predefined threshold number, the procedure returns to block S31 as described above. Otherwise, if the value of the counter is greater than the first predefined threshold number, in block S38, the counter checking module 103 determines whether the value of the counter is greater than a second predefined threshold number (e.g., 60 seconds).

If the value of the counter is no greater than the second predefined threshold number (i.e., the counter is between the first predefined threshold number and the second predefined threshold number), in block S39, the display mode controlling module 104 controls the display device 3 to work in a display protection mode, and then the procedure returns to block S31 as described above. Otherwise, if the value of the counter is equal or greater than the second predefined threshold number, in block S40, the display mode controlling module 104 controls the display device 3 to work in a power reducing mode, and then the procedure ends. When the display device 3 works in the power reducing mode, the display device 3 may shut down the power automatically.

All of the processes described above may be embodied in, and fully automated via, functional code modules executed by one or more general purpose processors or electronic devices. The functional code modules may be stored in any type of readable medium or other storage devices. Some or all of the methods may alternatively be embodied in specialized the electronic devices.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A computing system for reducing power consumption of a display device, the computing system comprising:
an electronic device connected with a video camera; and
a power consumption reducing system included in the electronic device, the power consumption reducing system comprising:
an image capturing module operable to control the video camera to capture an image of an object that is in front of the display device;
an image analyzing module operable to determine whether a user's eyes are viewing the display device by analyzing facial features of the captured image;
a counter checking module operable to initialize a counter as zero, and to increment the counter each second if the user's eyes are not viewing the display device; and
a display mode controlling module operable to control the display device to work in a normal display mode if the user's eyes are viewing the display device, to control the display device to work in a display protection mode upon condition that a value of the counter is more than a first predefined threshold number and less than a second predefined threshold number, and to control the display device to work in a power reducing mode upon condition that the value of the counter is not less than the second predefined threshold number.

2. The computing system according to claim 1, wherein the image analyzing module is further operable to detect the user's eyes in the captured image, determine whether the detected user's eyes are in a designated area in front of the display device, and determine whether the user's visual angle is within a preset visual angle range if the detected user's eyes are in the designated area.

3. The computing system according to claim 1, wherein the display mode controlling module is further operable to control the display device to work in the normal display mode upon condition that the value of the counter is not more than the first predefined threshold number.

4. The computing system according to claim 1, wherein the first predefined threshold number and the second predefined threshold number are predefined according to user's requirements.

5. A method for reducing power consumption of a display device, the method comprising:
initializing a counter as zero;
controlling a video camera to capture an image of an object that is in front of the display device;
determining whether a user's eyes are viewing the display device by analyzing facial features of the captured image;
controlling the display device to work in a normal display mode if the user's eyes are viewing the display device;
incrementing the counter each second if the user's eyes are not viewing the display device;
controlling the display device to work in a display protection mode upon condition that a value of the counter is more than a first predefined threshold number and less than a second predefined threshold number; and
controlling the display device to work in a power reducing mode upon condition that the value of the counter is not less than the second predefined threshold number.

6. The method according to claim 5, wherein the step of determining whether any user's eyes are viewing the display device comprises:
detecting the user's eyes in the captured image;
determining whether the detected user's eyes are in a designated area in front of the display device;
determining whether the user's visual angle is within a preset visual angle range if the detected user's eyes are in the designated area;
determining that the user's eyes are viewing the display device, if the user's visual angle is within the preset visual angle range; and
determining that the user's eyes are not viewing the display device, if the user's eyes are not in the designated area or the user's visual angle is not within the preset visual angle range.

7. The method according to claim 5, further comprising:
controlling the display device to work in the normal display mode upon condition that the value of the counter is not more than the first predefined threshold number.

8. The method according to claim 5, wherein the first predefined threshold number and the second predefined threshold number are predefined according to user's requirements.

9. A medium having stored thereon instructions that, when executed by a processor of an electronic device, cause the electronic device to perform a method for reducing power consumption of a display device, the method comprising:
initializing a counter as zero;
controlling a video camera to capture an image of an object that is in front of the display device;
determining whether a user's eyes are viewing the display device by analyzing facial features of the captured image;
controlling the display device to work in a normal display mode if the user's eyes are viewing the display device;
incrementing the counter each second if the user's eyes are not viewing the display device;
controlling the display device to work in a display protection mode upon condition that a value of the counter is more than a first predefined threshold number and less than a second predefined threshold number; and
controlling the display device to work in a power reducing mode upon condition that the value of the counter is not less than the second predefined threshold number.

10. The medium according to claim 9, wherein the step of determining whether any user's eyes are viewing the display device comprises:
detecting the user's eyes in the captured image;
determining whether the detected user's eyes are in a designated area in front of the display device;
determining whether the user's visual angle is within a preset visual angle range if the detected user's eyes are in the designated area;
determining that the user's eyes are viewing the display device, if the user's visual angle is within the preset visual angle range; and
determining that the user's eyes are not viewing the display device, if the user's eyes are not in the designated area or the user's visual angle is not within the preset visual angle range.

11. The medium according to claim 9, wherein the method further comprises:
controlling the display device to work in the normal display mode upon condition that the value of the counter is not more than the first predefined threshold number.

12. The medium according to claim 9, wherein the first predefined threshold number and the second predefined threshold number are predefined according to user's requirements.
